(19) United States
(12) Patent Application Publication
(10) Pub. No.: US 2020/0201571 A1
(43) Pub. Date: Jun. 25, 2020

(54) MEMORY SYSTEM AND OPERATING METHOD THEREOF

(71) Applicant: SK hynix Inc., Gyeonggi-do (KR)

(72) Inventors: Seung Wan JUNG, Gyeonggi-do (KR); Gi Seob CHANG, Gyeonggi-do (KR)

(21) Appl. No.: 16/530,664

(22) Filed: Aug. 2, 2019

(30) Foreign Application Priority Data
Dec. 19, 2018 (KR) 10-2018-0165626

(51) Int. Cl. G06F 3/06; G06F 12/0862

(52) U.S. Cl. CPC G06F 3/0659; G06F 3/0611; G06F 2212/602; G06F 3/0656; G06F 12/0862; G06F 3/0679

(57) ABSTRACT

There are provided a memory system and an operating method thereof. The memory system includes: a memory device configured to perform a write operation and a read operation of data; and a controller configured to control the memory device to perform the write operation and the read operation in response to commands received from a host, wherein the controller controls the memory device, in response to a read command corresponding to the read operation among the received commands, to perform the read operation on data at a first address corresponding to the read command and perform a pre-read operation on data at a second address corresponding to a read command not yet received, transmit read data corresponding to the read operation to the host, and store pre-read data corresponding to the pre-read operation.

### CROSS-REFERENCE TO RELATED APPLICATION

The present application claims priority under 35 U.S.C. § 119(a) to Korean patent application number 10-2018-0165626, filed on Dec. 19, 2018, which is incorporated herein by reference in its entirety.

### BACKGROUND

### Field of Invention

The present disclosure generally relates to an electronic device, and more particularly, to a memory system and an operating method thereof.

### Description of Related Art

The paradigm on recent computer environment has transitioned to ubiquitous computing in which computing systems can be used anywhere and anytime. This promotes increasing usage of portable electronic devices such as mobile phones, digital cameras, notebook computers, and the like. Such portable electronic devices may generally include a memory system using a memory device, i.e., a data storage device, which may be used as a main memory device or an auxiliary memory device of the portable electronic devices.

A data storage device used as a memory device has excellent stability and durability, high information access speed, and low power consumption, since there is no mechanical driving part. In the context of memory systems having such advantages, a data storage device includes a Universal Serial Bus (USB) memory device, memory cards having various interfaces, a Solid State Drive (SSD), and the like.

A memory device may be a volatile memory device or a nonvolatile memory device.

A nonvolatile memory device has relatively slow write and read speeds, but retains stored data even when the supply of power is interrupted. Thus, a nonvolatile memory device is used to store data to be retained regardless of whether power is supplied.

Examples of a volatile memory include a Read Only Memory (ROM), a Mask ROM (MROM), a Programmable ROM (PROM), an Electrically Programmable ROM (EPROM), an Electrically Erasable and Programmable ROM (EEPROM), a flash memory, a Phase-change RAM (PRAM), a Magnetic RAM (MRAM), a Resistive RAM (RRAM), a Ferroelectric RAM (FRAM), and the like. The flash memory may be a NOR type flash memory or a NAND type flash memory.

### SUMMARY

Embodiments provide a memory system capable of improving the operational performance thereof when a write command and a read command are simultaneously received, and an operating method of the memory system.

According to an aspect of the present disclosure, there is provided a memory system including: a memory device configured to perform a write operation and a read operation of data; and a controller configured to control the memory device to perform the write operation and the read operation in response to commands received from a host, wherein the controller controls the memory device, in response to a read command corresponding to the read operation among the received commands, to perform the read operation on data at a first address corresponding to the read command and perform a pre-read operation on data at a second address corresponding to a read command not yet received, transmit read data corresponding to the read operation to the host, and store pre-read data corresponding to the pre-read operation.

According to another aspect of the present disclosure, there is provided a memory system including: a memory device configured to perform a write operation, a read operation, and a pre-read operation; and a controller configured to control the memory device to perform the write operation and the read operation in response to a host command received from a host, and control the memory device to perform a pre-read operation on a specific address before the host command corresponding to the specific address is received, wherein the controller selects the specific address at which the pre-read operation is to be performed based on a Read Look Ahead (RLA) method, receives from the memory device pre-read data read obtained by performing the pre-read operation from the memory device, stores the pre-read data, and transmits the pre-read data to the host when the host command received after the pre-read operation corresponds to the specific address.

According to still another aspect of the present disclosure, there is provided a method for operating a memory system, the method including: performing a pre-read operation of a memory device before a host command is received from a host; receiving, from the device, pre-read data read obtained by performing the pre-read operation, and storing the pre-read data in a controller; storing, when the host command including a write command and a read command is received from the host after the pre-read operation, write data corresponding to the write command in the controller; determining whether the read command corresponds to the pre-read data; and performing, when it is determined when the read command corresponds to the pre-read data, in parallel an operation of transmitting the write data to the memory device and an operation of transmitting the pre-read data to the host.

According to another aspect of the present disclosure, there is provided a memory system including: a memory device in which data is stored and from which data is read; and a controller configured to: control the memory device to perform a pre-read operation of reading data according to a read look ahead (RLA) scheme and to buffer the data read in the pre-read operation (pre-read data); and provide the buffered pre-read data to an external source in response to a read request for the pre-read data from the external source while controlling the memory device to perform a write operation in response to a write request from the external source, wherein the pre-read data is, among data stored in the memory device, at least one of frequently read-requested data, data determined based on a pattern of previous read requests, data of a logical address next to a last logical address from which data was read.

### BRIEF DESCRIPTION OF THE DRAWINGS

Various embodiments are described more fully below with reference to the accompanying drawings; however, elements and features of the present invention may be configured or arranged differently than in the disclosed embodiments. Thus, the present invention is not limited to the embodiments set forth herein. Rather, these embodiments are provided so that this disclosure is thorough and complete and fully conveys the scope of the example embodiments to those skilled in the art. Throughout the specification, reference to “an embodiment,” “another embodiment” or the like is not necessarily to only one embodiment, and different references to any such phrase are not necessarily to the same embodiment(s).

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is a block diagram illustrating a memory system according to an embodiment of the present disclosure.

FIG. 2 is a block diagram illustrating a configuration of a controller, such as that shown in FIG. 1.

FIG. 3 is a diagram illustrating a semiconductor memory, such as that shown in FIG. 1.

FIG. 4 is a diagram illustrating a memory block, such as that shown in FIG. 3.

FIG. 5 is a diagram illustrating an embodiment of a three-dimensionally configured memory block.

FIG. 6 is a diagram illustrating another embodiment of a three-dimensionally configured memory block.

FIG. 7 is a flowchart illustrating an operation of the memory system according to an embodiment of the present disclosure.

FIG. 8 is a configuration diagram illustrating a data transmission order of the memory system according to an embodiment of the present disclosure.

FIG. 9 is a diagram illustrating an embodiment of the memory system.

FIG. 10 is a diagram illustrating an embodiment of the memory system.

FIG. 11 is a diagram illustrating an embodiment of the memory system.

FIG. 12 is a diagram illustrating an embodiment of the memory system.

### DETAILED DESCRIPTION

The specific structural and functional description disclosed herein is merely for the purpose of describing embodiments of the present disclosure. The present invention, however, may be implemented in other ways. Thus, the present invention is not limited to the embodiments set forth herein.

While the embodiments herein are described in detail, the present invention is not limited to specific details. Rather, the present invention includes all modifications, changes, equivalents, and substitutes that do not depart from the spirit and technical scope of the present invention.

While terms such as “first” and “second” may be used to identify various components, such components are not limited by the above terms. The above terms are used only to distinguish one component from another that otherwise have the same or similar names. For example, a first component may be referred to as a second component and vice versa, without departing from the scope of the present invention.

It will be understood that when an element is referred to as being “connected” or “coupled” to another element, it can be directly connected or coupled to the other element or one or more intervening elements may be present. In contrast, when an element is referred to as being “directly connected” or “directly coupled” to another element, no intervening elements are present. Other expressions describing relationships between components, such as “˜between,” “immediately˜between,” “adjacent to˜” and “directly adjacent to˜” may be construed similarly.

The terms used in the present application are merely used to describe particular embodiments, and are not intended to limit the present invention. Singular forms in the present disclosure are intended to include the plural forms and vice versa, unless the context clearly indicates otherwise. It will be further understood that terms such as “including” or “having,” etc., are intended to indicate the existence of the features, numbers, operations, actions, components, parts, or combinations thereof, but are not intended to preclude the possibility that one or more other features, numbers, operations, actions, components, parts, or combinations thereof may exist or may be added.

So far as not being differently defined, all terms used herein including technical or scientific terminologies have meanings that they are commonly understood by those skilled in the art to which the present disclosure pertains. Ordinary dictionary defined terms should be understood such that they have meanings consistent with the context of the related technique. So far as not being clearly defined in this application, terms should not be understood in an ideally or excessively formal way.

In describing embodiments, description of techniques that are well known to the art to which the present disclosure pertains and not directly related to the present disclosure is omitted. This intends to more clearly present aspects and features of the present invention.

Various embodiments of the present disclosure are described in detail below with reference to the accompanying drawings in order for those skilled in the art to be able to readily practice the present invention.

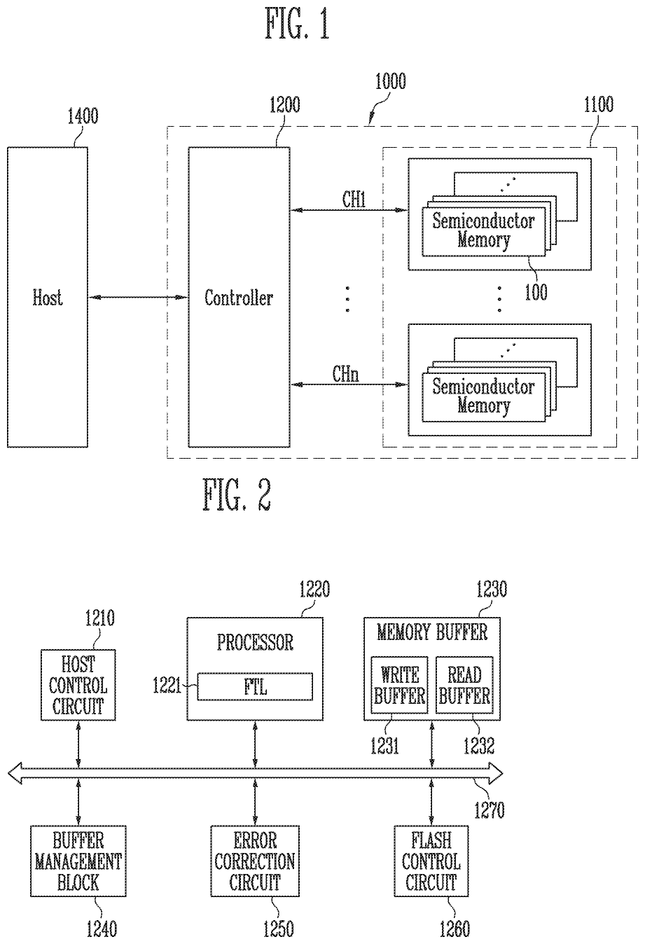

FIG. 1 is a block diagram illustrating a memory system according to an embodiment of the present disclosure.

Referring to FIG. 1, the memory system 1000 includes a memory device 1100, and a controller 1200. The memory device 1100 includes a plurality of semiconductor memories 100. The plurality of semiconductor memories 100 may be divided into a plurality of groups. In another embodiment, the memory system 1000 may include the host 1400, as well as the controller 1200, and the memory device 1100.

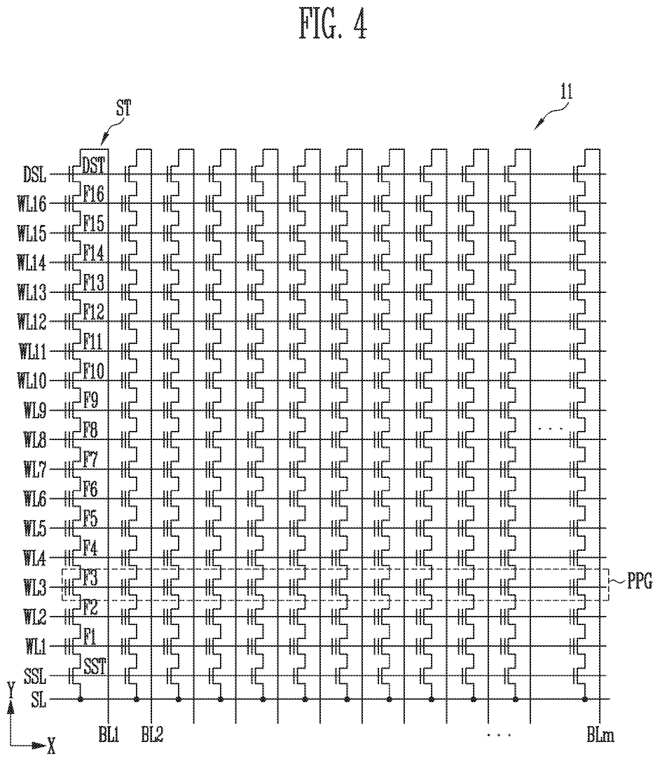

FIG. 1 illustrates that the plurality of, e.g., n, groups communicate with the controller 1200 respectively through first to nth channels CH1 to CHn. Each semiconductor memory 100 is described below with reference to FIG. 3.

Each of the semiconductor memories 100 in a given group communicates with the controller 1200 through one common channel. The controller 1200 controls the plurality of semiconductor memories 100 of the memory device 1100 through the plurality of channels CH to CHn.

The controller 1200 is coupled between the host 1400 and the memory device 1100. The controller 1200 accesses the memory device 1100 in response to a request from the host 1500. For example, the controller 1200 controls read, write, erase, and background operations of the memory device 1100 in response to commands received from the host 1400. The controller 1200 provides an interface between the memory device 1100 and the host 1400. The controller 1200 drives firmware for controlling the memory device 1100.

Also, the controller 1200 may control the memory device 1100 to perform a pre-read operation of reading data (pre-read data) before a read command for the pre-read data is received, based on a Read Look Ahead (RLA) method. The pre-read data may be stored in the controller 1200 during the pre-read operation. When a read command for the pre-read data is received from the host 1400, the pre-read data is output from the controller 1200 to the host 1400.

According to the RLA scheme, the data to be pre-read may be predictable. The data to be pre-read may be frequently read-requested data, data that can be predicted to be read soon based on a pattern of read requests and data of a logical address next to the last logical address of most recently read requested data. Since the host 1400 frequently requests data sequentially in terms of logical address, data of the logical address next to the last logical address of most recently read requested data can be predicted as data to be read soon and thus can be selected as the data to be pre-read.

The controller 1200 and the memory device 1100 may be integrated into one semiconductor device. In an embodiment, the controller 1200 and the memory device 1100 may be integrated into one semiconductor device, to constitute a memory card, such as a PC card (Personal Computer Memory Card International Association (PCMCIA)), a Compact Flash (CF) card, a Smart Media Card (SM or SMC), a memory stick, a Multi-Media Card (MMC, RS-MMC or MMCmicro), an SD card (SD, miniSD, microSD or SDHC), or a Universal Flash Storage (UFS).

The controller 1200 and the memory device 1100 may be integrated into one semiconductor device to constitute a semiconductor drive (Solid State Drive (SSD)). The semiconductor drive SSD includes a storage device configured to store data in a semiconductor memory. When the memory system 1000 is used as the semiconductor drive SSD, the operating speed of the host 1400 coupled to the memory system 1000 can be remarkably improved.

In another example, the memory system 1000 may be provided as one of various components of an electronic device such as a computer, an Ultra Mobile PC (UMPC), a workstation, a net-book, a Personal Digital Assistant (PDA), a portable computer, a web tablet, a wireless phone, a mobile phone, a smart phone, an e-book, a Portable Multi-Media Player (PMP), a portable game console, a navigation system, a black box, a digital camera, a 3-dimensional television, a digital audio recorder, a digital audio player, a digital picture recorder, a digital picture player, a digital video recorder, a digital video player, a device capable of transmitting/receiving information in a wireless environment, one of various electronic devices that constitute a home network, one of various electronic devices that constitute a computer network, one of various electronic devices that constitute a telematics network, an RFID device, or one of various components that constitute a computing system.

In an embodiment, the memory device 1100 or the memory system 1000 may be packaged in various forms. For example, the memory device 1100 or the memory system 1000 may be packaged as Package On Package (PoP), Ball Grid Arrays (BGAs), Chip Scale Packages (CSPs), Plastic Leaded Chip Carrier (PLCC), Plastic Dual In-line Package (PDIP die in Waffle pack, die in wafer form, Chip On Board (COB), CERamic Dual In-line Package (CERDIP), Plastic Metric Quad Flat Pack (PMQFP), Thin Quad Flat Pack (TQFP), Small Outline Integrated Circuit (SOIC), Shrink Small Outline Package (SSOP), Thin Small Outline Package (TSOP), Thin Quad Flat Pack (TQFP), System In Package (SIP), Multi-Chip Package (MCP), Wafer-level Fabricated Package (WFP), or Wafer-level processed Stack Package (WSP).

The host 1400 controls the memory system 1000. The host 1400 includes portable electronic devices such as a computer, a PDA, a PMP, an MP3 player, a camera, a camcorder, and a mobile phone. The host 1400 may request a write operation, a read operation, an erase operation, etc. of the memory system 1000 through a command. The host 1400 may simultaneously output a plurality of commands to the memory system 1000. For example, the host 1400 may simultaneously output a plurality of commands including a write command and a read command to the controller 1200 of the memory system 1000.

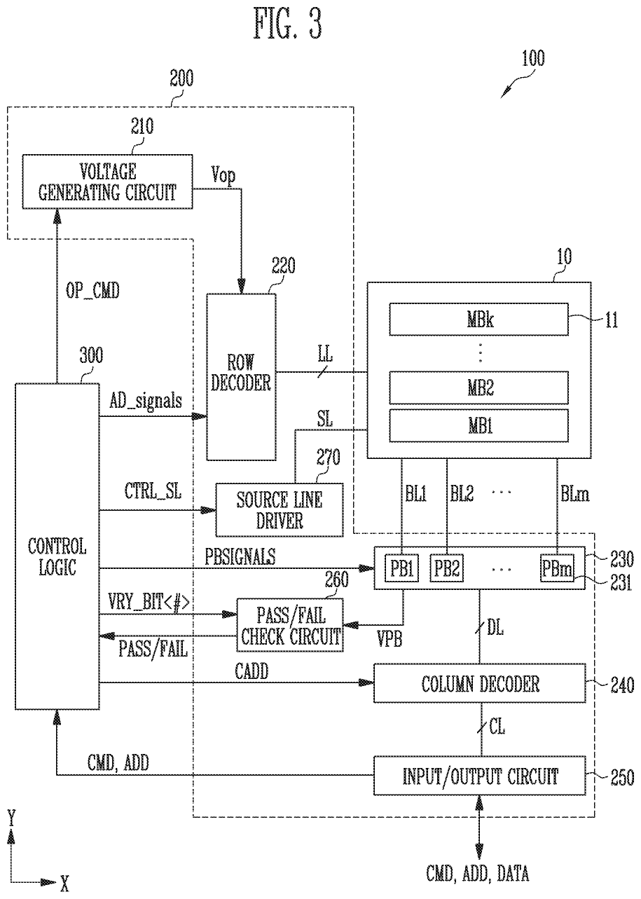

FIG. 2 is a block diagram illustrating an exemplary configuration of the controller shown in FIG. 1.

Referring to FIG. 2, the controller 1200 may include a host control circuit 1210, a processor 1220, a memory buffer 1230, a buffer management block 1240, an error correction circuit 1250, a flash control circuit 1260, and a bus 1270.

The bus 1270 may provide a channel between components of the controller 1200.

The host control circuit 1210 may control data transmission between the host 1400 shown in FIG. 1 and the memory buffer 1230. In an example, the host control circuit 1210 may control an operation of buffering data input from the host 1400 to the memory buffer 1230. In another example, the host control circuit 1210 may control an operation of outputting the data buffered to the memory buffer 1230 to the host 1400. The host control circuit 1210 may include a host interface.

The processor 1220 may control the overall operations of the controller 1200, and perform a logical operation. The processor 1220 may communicate with the host 1400 shown in FIG. 1 through the host control circuit 1210, and communicate with the memory device 1100 shown in FIG. 1 through the flash control circuit 1260. Also, the processor 1220 may control an operation of the memory system 1000 by using the memory buffer 1230 as a working memory, cache memory or buffer memory. Also, the processor 1220 may control the memory buffer 1230. The processor 1220 may control the flash control circuit 1260 by generating a command queue by reordering a plurality of commands received from the host 1400 according to an order of priority. Also, in a pre-read operation, the processor 1220 may control the flash control circuit 1260 by generating a command queue corresponding to the pre-read operation and an address of the pre-read data on which the pre-read operation is to be performed.

The processor 1220 may include a Flash Translation Layer (FTL) 1221.

The FTL 1221 drives firmware stored in the memory buffer 1230. Also, in a data write operation, the FTL 1221 may map a corresponding physical address to a logical address input from the host 1400 shown in FIG. 1. Also, in a data read operation, the FTL 1221 checks the physical address mapped to the logical address input from the host 1400.

Also, the FTL 1221 may generate a command queue for controlling the memory device 1100 to perform a pre-read operation of reading pre-read data, based on the RLA method, before a read command for the pre-read data is received from the host 1400, and generate a command queue for controlling the memory device 1100 to perform a write operation and a read operation in response to a write command and a read command, which are received from the host 1400.

The memory buffer 1230 may be used as a working memory, cache memory or data buffer memory of the processor 1220. The memory buffer 1230 may store codes and commands, which are executed by the processor 1220. The memory buffer 1230 may store data processed by the processor 1220.

The memory buffer 1230 may include a write buffer 1231 and a read buffer 1232. The write buffer 1231 temporarily stores write data received together with a write command from the host 1400 and then transmits the temporarily stored write data to the memory device 1100 when the write command is transmitted to the memory device 1100. The read buffer 1232 temporarily stores read data received from the memory device 1100 in a read operation and then transmits the temporarily stored read data to the host 1400. Also, the read buffer 1232 stores pre-read data received from the memory device 1100 in a pre-read operation. Subsequently, when a read command for the pre-read data is received from the host 1400, the read buffer 1232 transmits the stored pre-read data to the host 1400.

The memory buffer 1230 may include a Static RAM (SRAM) or Dynamic RAM (DRAM).

The buffer management block 1240 may control the memory buffer 1230. For example, when write data received together with a write command from the host 1400 is stored in the memory buffer 1230, and a read command is received from the host 1400, the buffer management block 1240 may control the memory buffer 1230 such that read data received from the memory device 1100 is stored in the memory buffer 1230. Also, when pre-read data read through a pre-read operation performed by the memory device 1100, based on the RLA method, is stored in the memory buffer 1230, and a read command for the pre-read data stored in the memory buffer 1230 is received from the host 1400, the buffer management block 1240 may control the memory buffer 1230 such that the pre-read data stored in the memory buffer 1230 is output to the host 1400.

The error correction circuit 1250 may perform error correction. The error correction circuit 1250 may perform Error Correction Code (ECC) encoding, based on write data to be written to the memory device 1100 shown in FIG. 1 through the flash control circuit 1260. The ECC-encoded data may be transferred to the memory device 1100 through the flash control circuit 1260. The error correction circuit 1250 may perform ECC decoding on read data and pre-read data, which are received from the memory device 1100, through the flash control circuit 1260. In an example, the error correction circuit 1250 may be included as a component of the flash control circuit 1260 therein.

The flash control circuit 1260 generates and outputs an internal command for controlling the memory device 1100 in response to the command queue generated by the processor 1220. In a data write operation, the flash control circuit 1260 may control a write operation by transmitting data buffered to the write buffer 1231 of the memory buffer 1230 to the memory device 1100. In another example, in a read operation and a pre-read operation, the flash control circuit 1260 may control an operation of buffering read data and pre-read data, which are read from the memory device 1100, to the memory buffer 1230 in response to a command queue. The flash control circuit 1260 may include a flash interface.

FIG. 3 is a diagram illustrating an example of the semiconductor memory 100 shown in FIG. 1.

Referring to FIG. 3, the semiconductor memory 100 may include a memory cell array 10 that stores data. The semiconductor memory 100 may include a peripheral circuit 200 configured to perform a program operation for storing data in the memory cell array 10, a read operation for outputting the stored data, and an erase operation for erasing the stored data. The semiconductor memory 100 may include control logic 300 that controls the peripheral circuit 200 under the control of the controller 1200 shown in FIG. 1.

The memory cell array 10 may include a plurality of memory blocks MB1 to MBk (k is a positive integer) 11. Local lines LL and bit lines BL1 to BLm (m is a positive integer) may be coupled to the memory blocks MB1 to MBk 11. For example, the local lines LL may include a first select line, a second select line, and a plurality of word lines arranged between the first and second select lines. Also, the local lines LL may further include dummy lines arranged between the first select line and the word lines and between the second select line and the word lines. The first select line may be a source select line, and the second select line may be a drain select line. For example, the local lines LL may include word lines, drain and source select lines, and source lines SL. For example, the local lines LL may further include dummy lines. For example, the local lines LL may further include pipe lines. The local lines LL may be coupled to the memory blocks MB1 to MBk 11, respectively, and the bit lines BL1 to BLm may be commonly coupled to the memory blocks MB1 to MBk 11. The memory blocks MB1 to MBk 11 may be implemented in a two-dimensional or three-dimensional structure. For example, memory cells may be arranged in a direction parallel to a substrate in memory blocks 11 having a two-dimensional structure. For example, memory cells may be arranged in a direction vertical to a substrate in memory blocks 11 having a three-dimensional structure.

The peripheral circuit 200 may be configured to perform program, read, and erase operations of a selected memory block 11 under the control of the control logic 300. For example, the peripheral circuit 200 may include a voltage generating circuit 210, a row decoder 220, a page buffer group 230, a column decoder 240, an input/output circuit 250, a pass/fail check circuit 260, and a source line driver 270.

The voltage generating circuit 210 may generate various operating voltages Vop used for program, read, and erase operations in response to an operation signal OP_CMD. Also, the voltage generating circuit 210 may selectively discharge the local lines LL in response to the operation signal OP_CMD. For example, the voltage generating circuit 210 may generate a program voltage, a verify voltage, a pass voltage, and a select transistor operation voltage under the control of the control logic 300.

The row decoder 220 may transfer the operating voltages Vop to local lines LL coupled to the selected memory block 11 in response to control signals AD_signals. For example, the row decoder 220 may selectively apply operation voltages (e.g., a program voltage, a verify voltage, a pass voltage, and the like) generated by the voltage generating circuit 210 to word lines among the local lines LL in response to the control signals AD_signals.

In a program voltage applying operation, the row decoder 220 applies a program voltage generated by the voltage generating circuit 210 to a selected word line among the local lines LL in the control signals AD_signals, and applies a pass voltage generated by the voltage generating circuit 210 to the other unselected word lines. Also, in a read operation, the row decoder 220 applies a read voltage generated by the voltage generating circuit 210 to a selected word line among the logical lines LL in response to the control signals AD_signals, and applies a pass voltage generated by the voltage generating circuit 210 to the other unselected word lines.

The page buffer group 230 may include a plurality of page buffers PB1 to PBm 231 coupled to the bit lines BL1 to BLm. The page buffers PB1 to PBm 231 may operate in response to page buffer control signals PBSIGNALS. For example, the page buffers PB1 to PBm 231 may temporarily store data to be programmed in a program operation, or sense voltages or currents of the bit lines BL1 to BLm in a read or verify operation.

The column decoder 240 may transfer data between the input/output circuit 250 and the page buffer group 230 in response to a column address CADD. For example, the column decoder 240 may exchange data with the page buffers 231 through data lines DL, or exchange data with the input/output circuit 250 through column lines CL.

The input/output circuit 250 may transfer a command CMD and an address ADD, which are received from the controller 1200 shown in FIG. 1, to the control logic 300, or exchange data DATA with the column decoder 240.

In a read operation or verify operation, the pass/fail check circuit 260 may generate a reference current in response to a allow bit VRY_BIT<#>, and output a pass signal PASS or a fail signal FAIL by comparing a sensing voltage VPB received from the page buffer group 230 with a reference voltage generated by the reference current.

The source line driver 270 may be coupled to a memory cell included in the memory cell array 10 through a source line SL, and control a voltage applied to the source line SL. The source line driver 270 may receive a source line control signal CTRL_SL from the control logic 300, and control a source line voltage applied to the source line SL, based on the source line control signal CTRL_SL.

The control logic 300 may control the peripheral circuit 200 by outputting the operation signal OP_CMD, the control signals AD_signals, the page buffer control signals PBSIGNALS, and the allow bit VRY_BIT<#>in response to the command CMD and the address ADD. Also, the control logic 300 may determine whether the verify operation has passed or failed in response to the pass or fail signal PASS or FAIL.

FIG. 4 is a diagram illustrating an exemplary memory block shown in FIG. 3.

Referring to FIG. 4, in the memory block 11, a plurality of word lines arranged in parallel to one another may be coupled between a first select line and a second select line. The first select line may be a source select line SSL, and the second select line may be a drain select line DSL. More specifically, the memory block 11 may include a plurality of strings ST coupled between bit lines BL1 to BLm and a source line SL. The bit lines BL1 to BLm may be coupled to the strings ST, respectively, and the source line SL may be commonly coupled to the strings ST. The strings ST may be configured identically to one another, and therefore, a string ST coupled to a first bit line BL1 will be described in detail as an example.

The string ST may include a source select transistor SST, a plurality of memory cells F1 to F16, and a drain select transistor DST, which are coupled in series to each other between the source line SL and the first bit line BL1. At least one source select transistor SST and at least one drain select transistor DST may be included in one string ST. Also, more than the 16 memory cells F1 to F16 shown in the drawing may be included in one string ST.

A source of the source select transistor SST may be coupled to the source line SL, and a drain of the drain select transistor DST may be coupled to the first bit line BL1. The memory cells F1 to F16 may be coupled in series between the source select transistor SST and the drain select transistor DST. Gates of source select transistors SST included in different strings ST may be coupled to the source select line SSL, gates of drain select transistors DST included in different strings ST may be coupled to the drain select line DSL, gates of the memory cells F1 to F16 included in different strings ST may be coupled to a plurality of word lines WL1 to WL16. A group of memory cells coupled to the same word line among the memory cells included in different strings ST may be a physical page PPG. Therefore, physical pages PPG of which number corresponds to that of the word lines WL1 to WL16 may be included in the memory block 110.

One memory cell may store data of one bit. This memory cell is generally referred to as a single level cell (SLC). One physical page PPG may store one logical page (LPG) data. The one LPG data may include data bits corresponding to the number of cells included in one physical page PPG. Also, one memory cell may store data of two or more bits. This memory cell is generally referred to as a multi-level cell (MLC). One physical page PPG may store two or more LPG data.

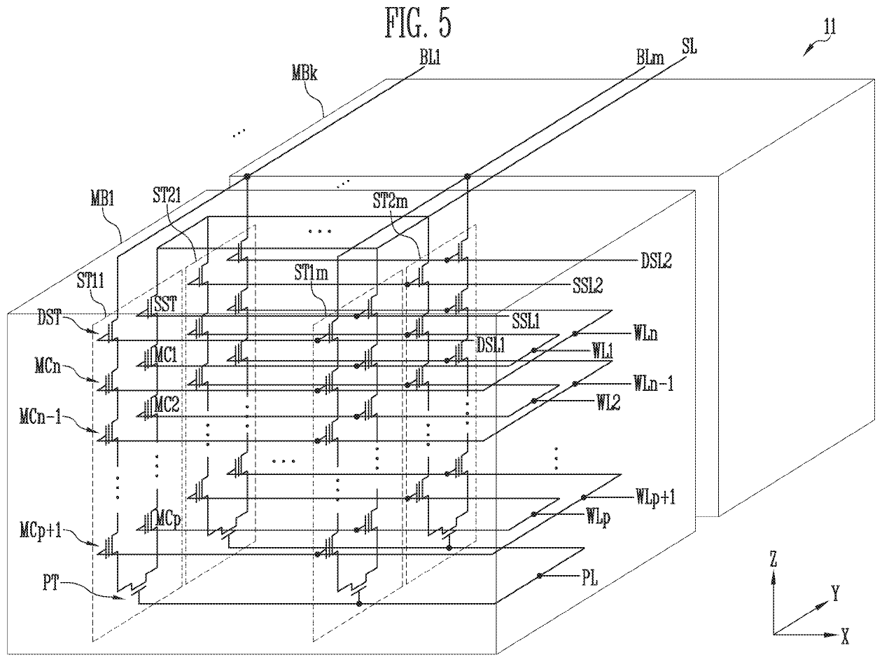

FIG. 5 is a diagram illustrating an embodiment of a three-dimensionally configured memory block.

Referring to FIG. 5, the memory cell array 10 may include memory blocks MB1 to MBk 11. The memory block 11 may include a plurality of strings ST11 to ST1m and ST21 to ST2m. In an embodiment, each of the plurality of strings ST11 to ST1m and ST21 to ST2m may be formed in a ‘U’ shape. In the memory block 11, m strings may be arranged in a row direction (X direction). Although a case where two strings are arranged in a column direction (Y direction) is illustrated in FIG. 5, this is for clarity; three or more strings may be arranged in the column direction (Y direction).

Each of the plurality of strings ST11 to ST1m and ST21 to ST2m may include at least one source select transistor SST, first to nth memory cells MC1 to MCn, a pipe transistor PT, and at least one drain select transistor DST.

The source and drain select transistors SST and DST and the memory cells MC1 to MCn may have structures similar to one another. For example, each of the source and drain select transistors SST and DST and the memory cells MC1 to MCn may include a channel layer, a tunnel insulating layer, a charge trapping layer, and a blocking insulating layer. For example, a pillar for providing the channel layer may be provided in each string. For example, a pillar for providing at least one of the channel layer, the tunnel insulating layer, the charge trapping layer, and the blocking insulating layer may be provided in each string.

The source select transistor SST of each string may be coupled between a source line SL and memory cells MC1 to MCp.

In an embodiment, source select transistors of strings arranged in the same row may be coupled to a source select line extending in the row direction, and source select transistors of strings arranged in different rows may be coupled to different source select lines. In FIG. 5, source select transistors of strings ST11 to ST1m of a first row may be coupled to a first source select line SSL1. Source select transistors of strings ST21 to ST2m of a second row may be coupled to a second source select line SSL2.

In another embodiment, the source select transistors of the strings ST11 to ST1m and ST21 to ST2m may be commonly coupled to one source select line.

First to nth memory cells MC1 to MCn of each string may be coupled between the source select transistor SST and the drain select transistor DST.

The first to nth memory cells MC1 to MCn may be divided into first to pth memory cells MC1 to MCp and (p+1)th to nth memory cells MCp+1 to MCn. The first to pth memory cells MC1 to MCp may be sequentially arranged in a vertical direction (Z direction), and be coupled in series to each other between the source select transistor SST and the pipe transistor PT. The (p+1)th to nth memory cells MCp+1 to MCn may be sequentially arranged in the vertical direction (Z direction), and be coupled in series to each other between the pipe transistor PT and the drain select transistor DST. The first to pth memory cells MC1 to MCp and the (p+1)th to nth memory cells MCp+1 to MCn may be coupled to each other through the pipe transistor PT. Gates of the first to nth memory cells MC1 to MCn of each string may be coupled to first to nth word lines WL1 to WLn, respectively.

In an embodiment, at least one of the first to nth memory cells MC1 to MCn may be used as a dummy memory cell. When a dummy memory cell is provided, the voltage or current of a corresponding string can be stably controlled. A gate of the pipe transistor PT of each string may be coupled to a pipe line PL.

The drain select transistor DST of each string may be coupled to a bit line and the memory cells MCp+1 to MCn. Strings arranged in the row direction may be coupled to a drain select line extending in the row direction. Drain select transistors of the strings ST11 to ST1, of the first row may be coupled to a first drain select line DSL1. Drain select transistors of the strings ST21 to ST2m of the second row may be coupled to a second drain select line DSL2.

Strings arranged in the column direction may be coupled to bit lines extending in the column direction. In FIG, 5, strings ST11 and ST21 of a first column may be coupled to a first bit line BL1, Strings ST1m and ST2m of an mth column may be coupled to an mth bit line BLm.

Memory cells coupled to the same word line among the strings arranged in the row direction may constitute one page. For example, memory cells coupled to the first word line WL1 among the strings ST11 to ST1m of the first row may constitute one page. Memory cells coupled to the first word line WL1 among the strings ST21 to ST2m of the second row may constitute another page. When any one of the drain select lines DSL1 and DSL2 is selected, strings arranged in one row direction may be selected. When any one of the word lines WL1 to WLn is selected, one page among the selected strings may be selected.

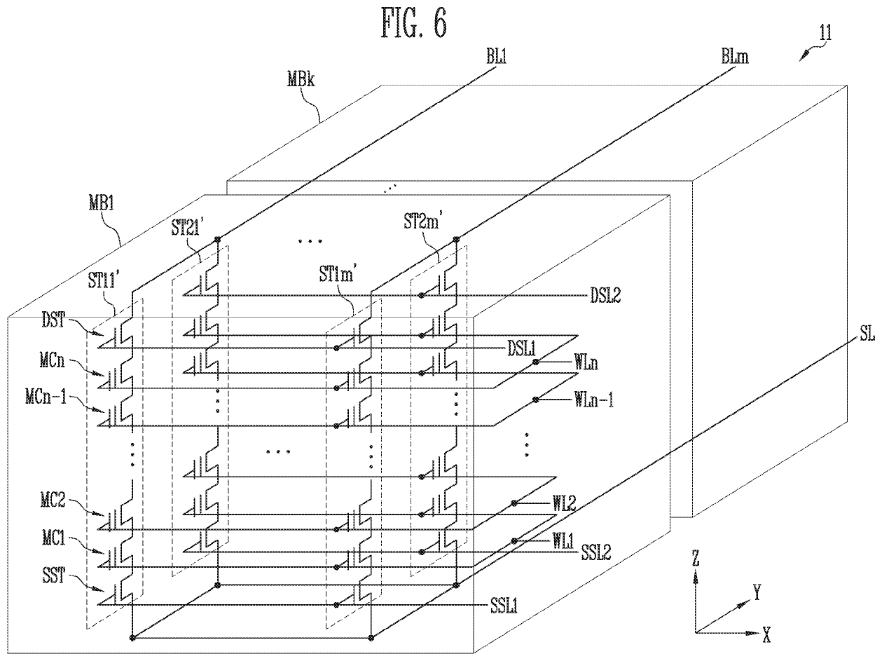

FIG. 6 is a diagram illustrating another embodiment of the three-dimensionally configured memory block.

Referring to FIG. 6, the memory cell array 10 may include a plurality of memory blocks MB1 to MBk 11. The memory block 11 may include a plurality of strings ST11′ to ST1m′ and ST21′ to ST2m′. Each of the plurality of strings ST11′ to ST1m′ and ST21′ to ST2m′ may extend along a vertical direction (Z direction). In the memory block 11, strings may be arranged in a row direction (X direction). Although a case where two strings are arranged in a column direction (Y direction) is illustrated in FIG. 6, this is for clarity; three or more strings may be arranged in the column direction (Y direction).

Each of the plurality of strings ST11′ to ST1m′ and ST21′ to ST2m′ may include at least one source select transistor SST, first to nth memory cells MC1 to MCn, and at least one drain select transistor DST.

The source select transistor SST of each string may be coupled between a source line SL and the memory cells MC1 to MCn. Source select transistors of strings arranged in the same row may be coupled to the same source select line. Source select transistors of strings ST11′ to ST1m′ arranged on a first row may be coupled to a first source select line SSL1. Source select transistors of strings ST21′ to ST2m′ arranged on a second row may be coupled to a second source select line SSL2. In another embodiment, the source select transistors of the strings ST11′ to ST1m′ and ST21′ to ST2m′ may be commonly coupled to one source select line.

The first to nth memory cells MC1 to MCn of each string may be coupled in series to each other between the source select transistor SST and the drain select transistor DST. Gates of the first to nth memory cells MC1 to MCn may be coupled to first to nth word lines WL1 to WLn, respectively.

In an embodiment, at least one of the first to nth memory cells MC1 to MCn may be used as a dummy memory cell. When a dummy memory cell is provided, the voltage or current of a corresponding string can be stably controlled. Accordingly, the reliability of data stored in the memory block 11 can be improved.

The drain select transistor DST of each string may be coupled between a bit line and the memory cells MC1 to MCn. Drain select transistors DST of strings arranged in the row direction may be coupled to a drain select line extending in the row direction. The drain select transistors DST of the strings ST11′ to ST1m′ of the first row may be coupled to a first drain select line DSL1. The drain select transistors DST of the strings ST21′ to ST2m′ of the second row may be coupled to a second drain select line DSL2.

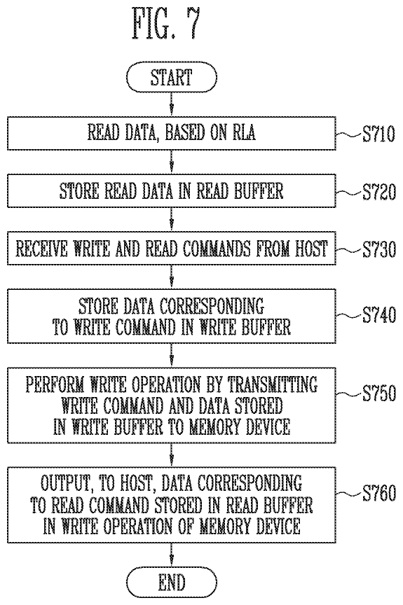

FIG. 7 is a flowchart illustrating an operation of a memory system, e.g., the memory system 1000, according to an embodiment of the present disclosure.

FIG. 8 is a diagram illustrating a data transmission order of a memory system, e.g., the memory system 1000, according to an embodiment of the present disclosure.

An operating method of the memory system according to an embodiment of the present disclosure is described below with reference to FIGS. 1 to 8.

The memory system 1000 performs a pre-read operation of reading in advance data DATA_D (pre-read data), which is predicted to be read in a next read operation, among data stored in the memory device 1100, based on the RLA method, before the next read command is received from the host 1400 (S710).

In the pre-read operation, the processor 1220 of the controller 1200 generates a command queue corresponding to the pre-read operation and an address of data on which the pre-read operation is to be performed, and the flash control circuit 1260 of the controller 1200 generates an internal command for controlling the pre-read operation of the memory device 1100 based on the command queue and then outputs the internal command together with the address to the memory device 1100.

The memory device 1100 reads pre-read data DATA_D by performing the pre-read operation in response to the received internal command and the received address.

The pre-read data read by the memory device 1100 is transmitted to the memory buffer 1230 of the controller 1200 (\textcircled{1}) and the buffer management block 1240 stores the pre-read data received from the memory device 1100 in the read buffer 1232 by controlling the memory buffer 1230 (S720).

After the pre-read operation, the controller 1200 receives a host command Host CMD (S730, \textcircled{2})). The host command including a write command and a read command may be received to the controller 1200. In an embodiment of the present disclosure, a case where the host command Host CMD including a plurality of write commands Write_A, Write_B, and Write_C and a read command Read_D is received as shown in FIG. 8 is described as an example.

The processor 1220 controls the memory buffer 1230 such that a plurality of write data (DATA_A, DATA_B, and DATA_C) received together with the plurality of write commands (Write_A, Write_B, and Write_C) are temporarily stored in the write buffer 1231 of the memory buffer 1230 (S740, \textcircled{3})).

Also, the processor 1220 determines whether the read command Read_D corresponds to pre-read data DATA_D stored in the read buffer 1232.

A case where it is determined that the read command Read_D corresponds to the pre-read data DATA_D stored in the read buffer 1232 is described as follows.

When it is determined that the read command Read_D corresponds to the pre-read data DATA_D stored in the read buffer 1232, the processor 1220 generates a command queue in response to the plurality of write commands Write_A, Write_B, and Write_C; the read command Read_D is not included in the command queue.

The flash control circuit 1260 generates internal commands for controlling a write operation of the memory device 1100 based on the command queue generated by the processor 1220. Also, the flash controller 1260 transmits the plurality of write data DATA_A, DATA_B, and DATA__C stored in the write buffer 1231 to the memory device 1100 (\textcircled{4}), and the memory device 1100 performs the write operation in response to the internal commands received from the controller 1200 and the plurality of write data DATA_A, DATA_B, and DATA_C (S750).

In the operation (\textcircled{4}) of transmitting the above-described write data DATA_A, DATA_B, and DATA_C to the memory device 1100, the pre-read data DATA_D corresponding to the read command Read_D stored in the read buffer 1232 is output to the host 1400 (S760). That is, the memory buffer 1230 may perform in parallel an operation of transmitting write data to the memory device 1100 and an operation of transmitting read data to the host 1400.

As described above, according to an embodiment of the present disclosure, data to be read in a next read operation, before a next read command is received from the host 1400, is stored in the read buffer 1232 by performing a pre-read operation by predicting the data. Also, an operation of performing a write operation by transmitting write data to the memory device and an operation of transmitting pre-read data are performed in parallel when a write command and the read command are simultaneously received from the host 1400, so that the operating speed of the memory system can be improved.

A case where the read command Read_D among the commands included in the host command received from the host 1400 does not correspond to the pre-read data DATA_D stored in the read buffer 1232 is described as follows

When it is determined that the read command Read_D does not correspond to the pre-read data DATA_D stored in the read buffer 1232, the processor 1220 generates a command queue in response to the plurality of write commands Write_A, Write_B, and Write_C and the read command Read_D.

The flash control circuit 1260 generates internal commands for controlling a write operation and a read operation of the memory device 1100 based on the command queue generated by the processor 1220, and transmits the internal commands to the memory device 1100. Also, the flash control circuit 1260 transmits the plurality of write data DATA_A, DATA_B, and DATA_C stored in the write buffer 1231 of the memory buffer 1230 to the memory device 1100.

The memory device 1100 sequentially performs the write operation and the read operation in response to the internal commands received from the controller 1200 and the plurality of write data DATA_A, DATA_B, and DATA_C.

Data read after the read operation is performed is temporarily stored in an empty space of the read buffer 1232 and then output to the host 1400.

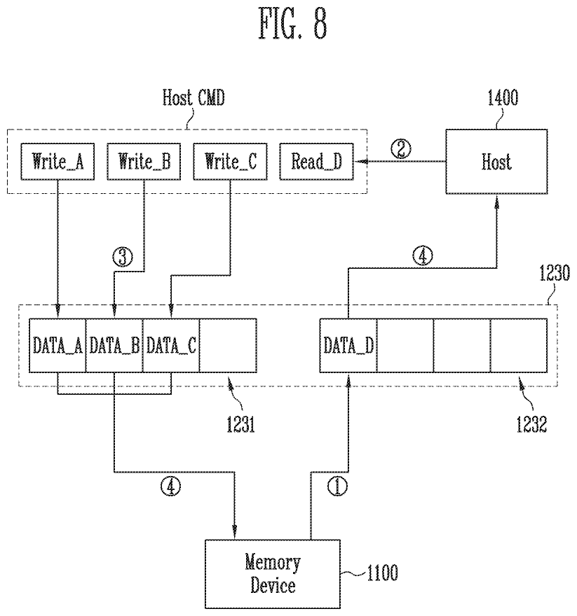

FIG. 9 is a diagram illustrating another embodiment of the memory system.

Referring to FIG. 9, the memory system 30000 may be implemented as a cellular phone, a smart phone, a tablet PC, a personal digital assistant (PDA), or a wireless communication device. The memory system 30000 may include a memory device 1100 and a controller 1200 capable of controlling an operation of the memory device 1100. The controller 1200 may control a data access operation of the memory device 1100, e.g., a program operation, an erase operation, a read operation, or the like under the control of a processor 3100.

Data programmed in the memory device 1100 may be output through a display 3200 under the control of the controller 1200.

A radio transceiver 3300 may transmit/receive radio signals through an antenna ANT. For example, the radio transceiver 3300 may convert a radio signal received through the antenna ANT into a signal that can be processed by the processor 3100. Therefore, the processor 3100 may process a signal output from the radio transceiver 3300 and transmit the processed signal to the controller 1200 or the display 3200. The controller 1200 may transmit the signal processed by the processor 3100 to the memory device 1100. Also, the radio transceiver 3300 may convert a signal output from the processor 3100 into a radio signal, and output the radio signal to an external device through the antenna ANT. An input device 3400 is a device capable of inputting a control signal for controlling an operation of the processor 3100 or data to be processed by the processor 3100, and may be implemented as a pointing device such as a touch pad or a computer mount, a keypad, or a keyboard. The processor 3100 may control an operation of the display 3200 such that data output from the controller 1200, data output from the radio transceiver 3300, or data output from the input device 3400 can be output through the display 3200.

In some embodiments, the controller 1200 capable of controlling an operation of the memory device 1100 may be implemented as a part of the processor 3100, or be implemented as a chip separate from the processor 3100. Also, the controller 1200 may be implemented with the controller shown in FIG. 2.

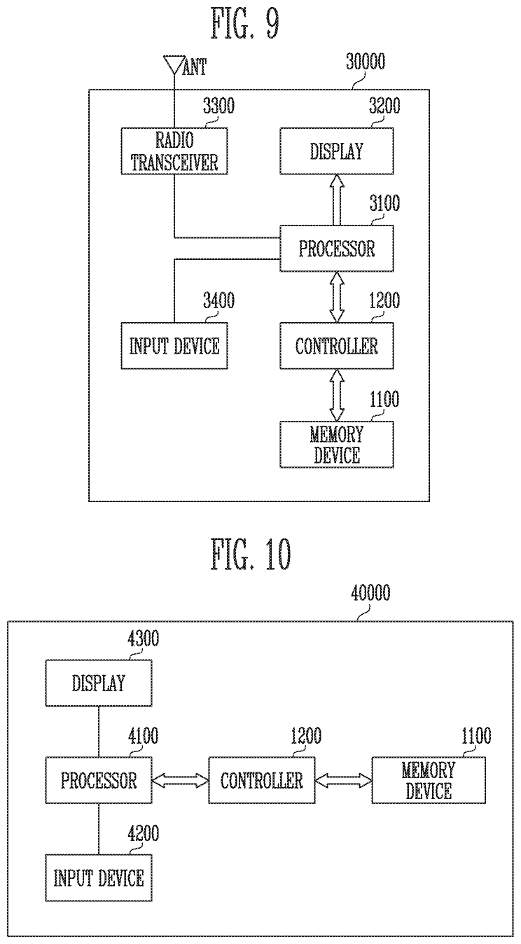

FIG. 10 is a diagram illustrating another embodiment of the memory system

Referring to FIG. 10, the memory system 40000 may be implemented as a personal computer (PC), a tablet PC, a net-book, an e-reader, a personal digital assistant (PDA), a portable multi-media player (PMP), an MP3 player, or an MP4 player.

The memory system 40000 may include a memory device 1100 and a controller 1200 capable of controlling a data processing operation of the memory device 1100.

A processor 4100 may output data stored in the memory device 1100 through a display 4300 according to data input through an input device 4200. For example, the input device 4200 may be implemented as a pointing device such as a touch pad or a computer mouse, a keypad, or a keyboard.

The processor 4100 may control overall operations of the memory system 40000, and control an operation of the controller 1200. In some embodiments, the controller 1200 capable of controlling an operation of the memory device 1100 may be implemented as a part of the processor 4100, or be implemented as a chip separate from the processor 4100. Also, the controller 1200 may be implemented with the controller shown in FIG. 2.

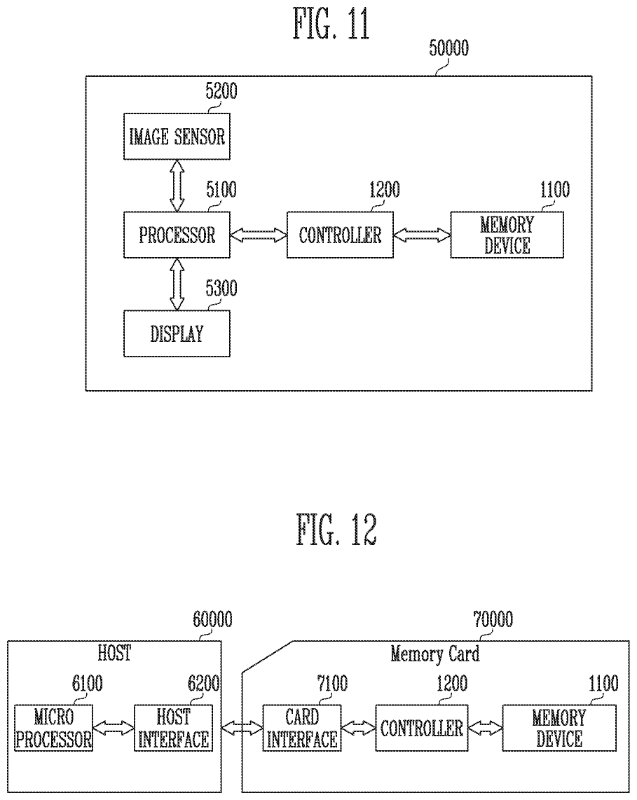

FIG. 11 is a diagram illustrating another embodiment of the memory system.

Referring to FIG. 11, the memory system 50000 may be implemented as an image processing device, e.g., a digital camera, a mobile terminal having a digital camera attached thereto, a smart phone having a digital camera attached thereto, or a tablet PC having a digital camera attached thereto.

The memory system 50000 may include a memory device 1100 and a controller 1200 capable of controlling a data processing operation of the memory device 1100, e.g., a program operation, an erase operation, or a read operation.

An image sensor 5200 of the memory system 50000 may convert an optical image into digital signals, and the converted digital signals may be transmitted to a processor 5100 or the controller 1200. Under the control of the processor 5100, the converted digital signals may be output through a display 5300, or be stored in the memory device 1100 through the controller 1200. In addition, data stored in the memory device 1100 may be output through the display 5300 under the control of the processor 5100 or the controller 1200.

In some embodiments, the controller 1200 capable of controlling an operation of the memory device 1100 may be implemented as a part of the processor 5100, or be implemented as a chip separate from the processor 5100. Also, the controller 1200 may be implemented with the controller shown in FIG. 2.

FIG. 12 is a diagram illustrating another embodiment of the memory system.

Referring to FIG. 12, the memory system 70000 may be implemented as a memory card or a smart card. The memory system 70000 may include a memory device 1100, a controller 1200, and a card interface 7100.

The controller 1200 may control data exchange between the memory device 1100 and the card interface 7100. In some embodiments, the card interface 7100 may be a secure digital (SD) card interface or a multi-media card (MMC) interface, but the present disclosure is not limited thereto. Also, the controller 1200 may be implemented with the controller shown in FIG. 2.

The card interface 7100 may interface data exchange between a host 60000 and the controller 1200 according to a protocol of the host 60000. In some embodiments, the card interface 7100 may support a universal serial bus (USB) protocol and an inter-chip (IC)-USB protocol. The card interface 7100 may mean hardware capable of supporting a protocol used by the host 60000, software embedded in the hardware, or a signal transmission scheme.

When the memory system 70000 is coupled to a host interface 6200 of the host 60000 such as a PC, a tablet PC, a digital camera, a digital audio player, a cellular phone, console video game hardware, or a digital set-top box, the host interface 6200 may perform data communication with the memory device 1100 through the card interface 7100 and the controller 1200 under the control of a microprocessor 6100.

According to embodiments of the present disclosure, data is pre-read from the memory device to be stored, and a write operation and a read operation are performed in parallel when a write command and a read command are simultaneously received from the host, so that the operation performance of the memory system can be improved.

While the present disclosure has been illustrated and described with reference to certain embodiments thereof, it will be understood by those skilled in the art in light of the present disclosure that various changes in form and details may be made therein without departing from the spirit and scope of the present invention as defined by the appended claims and their equivalents. Therefore, the scope of the present invention should not be limited to the above-described embodiments but should be determined by the appended claims and equivalents thereof.

In the above-described embodiments, one or more steps may be selectively performed in whole or in part or may be omitted. In each embodiment, the steps are not necessarily performed in accordance with the described order and may be rearranged. The embodiments disclosed in this specification and drawings are presented to facilitate an understanding of the present disclosure, but not to limit the present invention. To that end, while specific terms are used to explain the embodiments of the present disclosure, the present invention is not limited by those terms. That is, it should be apparent to those skilled in the art that various modifications can be made on the basis of the technological scope of the present disclosure. The present invention encompasses all such modifications to the extent they fall within the scope of the claims.

What is claimed is:

1. A memory system comprising:
a memory device configured to perform a write operation and a read operation of data; and
a controller configured to control the memory device to perform the write operation and the read operation in response to commands received from a host,
wherein the controller controls the memory device, in response to a read command corresponding to the read operation among the received commands, to perform the read operation on data at a first address corresponding to the read command and perform a pre-read operation on data at a second address corresponding to a read command not yet received, transmit read data corresponding to the read operation to the host, and store pre-read data corresponding to the pre-read operation.

2. The memory system of claim 1, wherein, when an address corresponding to a read command received after the pre-read operation is the second address, the controller transmits, to the host, the pre-read data in response to the read command received after the pre-read operation.

3. The memory system of claim 2, wherein, when the received command is a write command corresponding to the write operation, the controller transmits write data corresponding to the write command to the memory device.

4. The memory system of claim 3, wherein the controller includes:
a processor configured to generate a first command in response to the received commands, and generate a second command corresponding to the pre-read operation;
a memory buffer configured to store the write data, the read data, and the pre-read data; and
a flash control circuit configured to generate a first internal command for controlling the memory device to perform the write operation or the read operation in response to the first command or to generate a second internal command for controlling the memory device to perform the pre-read operation in response to the second command, and transmit the first internal command or the second internal command to is the memory device.

5. The memory system of claim 4, wherein the controller controls the memory buffer such that:
the pre-read data received from the memory device in the pre-read operation is stored in the memory buffer; and
the write data stored in the memory buffer is transmitted to the memory device in a section in which the pre-read data stored in the memory buffer is transmitted to the host.

6. The memory system of claim 4, wherein, when the read command received after the pre-read operation corresponds to the pre-read data, the controller controls the memory buffer such that the pre-read data stored in the memory buffer is transmitted to the host in a section in which the write data stored in the memory buffer is transmitted to the memory device.

7. The memory system of claim 4, wherein the processor generates the second command corresponding to the pre-read operation, based on a Read Look Ahead (RLA) method.

8. The memory system of claim 7, wherein the controller further includes a buffer management block configured to control the memory buffer such that the write data is stored in the memory buffer, and the read data and the pre-read data, which are received from the memory device, are stored in the memory buffer.

9. The memory system of claim 8, wherein the buffer management block controls the memory buffer to perform in parallel an operation of transmitting the write data to the memory device and an operation of transmitting the pre-read data to the host.

10. The memory system of claim 7, wherein the processor generates the second command by selecting, as the second address, an address having a high frequency of access, a logical address next to the first address, or an address at which the pre-read operation is predicted based on the first address.

11. A memory system comprising:
a memory device configured to perform a write operation, a read operation, and a pre-read operation; and
a controller configured to control the memory device to perform the write operation and the read operation in response to a host command received from a host, and control the memory device to perform a pre-read operation on a specific address before the host command corresponding to the specific address is received,
wherein the controller selects the specific address at which the pre-read operation is to be performed based on a Read Look Ahead (RLA) method, receives from the memory device pre-read data read obtained by performing the pre-read operation from the memory device, stores the pre-read data, and transmits the pre-read data to the host when the host command received after the pre-read operation corresponds to the specific address.

12. The memory system of claim 11, wherein the host command includes a write command corresponding to the write operation and a read command corresponding to the read operation.

13. The memory system of claim 12, wherein, when the read command included in the host command received after the pre-read operation corresponds to the specific address, the controller performs in parallel an operation of transmitting write data corresponding to the write command included in the host command to the memory device and an operation of transmitting the pre-read data to the host.

14. The memory system of claim 13, wherein the controller includes:
a processor configured to generate a first command queue in response to the received host command, and to generate a second command queue corresponding to the pre-read operation in response to the received command;
a memory buffer configured to store the write data, the read data, and the pre-read data; and
a flash control circuit configured to generate a first internal command for controlling the memory device to perform the write operation or the read operation in response to the first command queue or a second internal command for controlling the memory device to perform the pre-read operation in response to the second command queue, and transmit the first internal command or the second internal command to the memory device.

15. The memory system of claim 14, wherein the controller further includes a buffer management block configured to control the memory buffer such that the read data received from the memory device in the pre-read operation is stored in the memory buffer, and control the memory buffer such that the pre-read data stored in the memory buffer is transmitted to the host in a section in which the write data stored in the memory buffer is transmitted to the memory device.

16. The memory system of claim 15, wherein, when the read command included in the host command corresponds to the specific address, the buffer management block controls the memory buffer such that the pre-read data stored in the memory buffer is transmitted to the host in a section in which the write data stored in the memory buffer is transmitted to the memory device.

17. The memory system of claim 11, wherein controller selects the specific address such that it corresponds to data having a high frequency of access, data having a logical address next to that of last requested data, or data pre-read-predicted based on a use pattern of the host.

18. A memory system comprising:
a memory device in which data is stored and from which data is read; and
a controller configured to:
control the memory device to perform a pre-read operation of reading data according to a read look ahead (RLA) scheme and to buffer the data read in the pre-read operation (pre-read data); and
provide the buffered pre-read data to an external source in response to a read request for the pre-read data from the external source while controlling the memory device to perform a write operation in response to a write request from the external source,
wherein the pre-read data is, among data stored in the memory device, at least one of frequently read-requested data, data determined based on a pattern of previous read requests, data of a logical address next to a last logical address from which data was read.
